(19) United States
(12) Patent Application Publication
(10) Pub. No.: US 2015/0019246 A1
(43) Pub. Date: Jan. 15, 2015

(54) MEDICAL CARE INFORMATION DISPLAY CONTROL APPARATUS, METHOD, AND PROGRAM

(71) Applicant: FUJIFILM Corporation, Tokyo (JP)

(72) Inventors: Taisuke Inoue, Ashigarakami-gun (JP); Shoji Kanada, Ashigarakami-gun (JP)

(73) Assignee: FUJIFILM Corporation

(21) Appl. No.: 14/327,472

(22) Filed: Jul. 9, 2014

(30) Foreign Application Priority Data
Jul. 11, 2013 (JP) 2013-145247

(51) Int. Cl. G06F 19/00

(52) U.S. Cl. CPC G06F 19/322
USPC 705/2

(57) ABSTRACT

Among a plurality of medical care information sets, each correlating a plurality of medical care items, medical care data of a display target patient corresponding to each medical care item, and a registration reference time of the medical care data, obtaining a plurality of medical care information sets whose registration reference times fall within the target period as target medical care information. Among a plurality of medical care item groups, each correlating a plurality of medical care items to be displayed on a display screen, extracting a medical care item group that includes a medical care item of interest which is a predetermined medical care item included in the target medical care information as a display item group, and displaying medical care data of the display target patient corresponding to the plurality of medical care items included in the extracted display item group.

### CROSS-REFERENCE TO RELATED APPLICATIONS

The present application claims priority under 35 U.S.C. §119 to Japanese Patent Application No 2013-145247 filed on Jul. 11, 2013, the content of which is hereby expressly incorporated herein by reference in its entirety.

### BACKGROUND OF THE INVENTION

1. Field of the Invention

The present invention relates to a medical care information display control apparatus, method, and program for displaying medical care data of a plurality of medical care items.

2. Description of the Related Art

Recently, in the field of medicine, when a diagnosis is performed on a patient, a plurality of medical care information sets, such as the results of tests performed on the patient and the like, is displayed and used as the reference information for diagnosing the disease name, determining treatment policy, and the like.

There are a wide variety of types of tests that are performed on a patient and there is a demand in actual medical front that, when a patient is suspected to have a particular disease, medical care data of a predetermined medical care item which is noteworthy for the diagnosis of the specific disease can be get hold of more efficiently in the diagnosis.

Consequently, for example, Japanese Unexamined Patent Publication No. 2009-110282, Japanese Unexamined Patent Publication No. 2001-160110, Japanese Unexamined Patent Publication No 2007-226833, and PCT Japanese Publication No. 2004-529401 disclose a technology for displaying noteworthy medical care info/nation in an easily viewable manner by prioritizing and displaying medical care information, for example, by distinguishably displaying only the information that shows an abnormal value among medical care data of display target medical care information.

### SUMMARY OF THE INVENTION

In the mean time, there may be a case in which a sign of an abnormality should be judged, depending on the disease, by taking into consideration not only medical care data that shows an abnormal value but also medical care data of each of a plurality of predetermined medical care items in a comprehensive manner. There is a growing demand that the overlooking of medical care data of a medical care item that should be referenced in diagnosis is inhibited in order to perform accurate diagnosis, in particular, a case that shows complicated symptoms, such as a complicating disease and the like. But, the technology disclosed in Japanese Unexamined Patent Publication No. 2009-110282, Japanese Unexamined Patent Publication No. 2001-160110, Japanese Unexamined Patent Publication No. 2007-226833, and PCT Japanese Publication No. 2004-529401 does not, in particular, distinguishably display an item of a nature that does not show problems, such as an abnormal value and the like, among a plurality of medical care items to be referenced, and overlooking of medical care data of a medical care item which should be referenced in diagnosis by doctors may possibly occur.

In view of the circumstances described above, it is an object of the present invention to provide a medical care information display control apparatus, method, and program capable of property displaying a plurality of medical care items to be referenced in combination, thereby reducing overlooking of medical care information.

A medical care information display control apparatus of the present invention includes:

a target period obtaining unit that obtains a target period;

a medical care information obtaining unit that obtains a plurality of medical care information sets, each correlating a plurality of medical care items, medical care data of a display target patient corresponding to each medical care item, and a registration reference time of the medical care data, and obtains, among the plurality of medical care information sets, a plurality of medical care information sets whose registration reference times fall within the target period as target medical care information;

an item group extraction unit that obtains a plurality of medical care item groups, each correlating a plurality of medical care items to be displayed on a display screen and, from the plurality of medical care item groups, extracts a medical care item group that includes a medical care item of interest which is a predetermined medical care item included in the target medical care information as a display item group; and

a display control unit that displays medical care data of the display target patient corresponding to the plurality of medical care items included in the extracted display item group based on the plurality of medical care information sets.

A medical care information display control method of the present invention is a method to be performed by a medical care information display control apparatus, the method including:

a target period obtaining step that obtains a target period;

a medical care information obtaining step that obtains a plurality of medical care information sets, each correlating a plurality of medical care items, medical care data of a display target patient corresponding to each medical care item, and a registration reference time of the medical care data, and obtains, among the plurality of medical care information sets, a plurality of medical care information sets whose registration reference times fall within the target period as target medical care information;

an item group extraction step that obtains a plurality of medical care item groups, each correlating a plurality of medical care items to be displayed on a display screen and, from the plurality of medical care item groups, extracts a medical care item group that includes a medical care item of interest which is a predetermined medical care item included in the target medical care information as a display item group; and

a display control step that displays medical care data of the display target patient corresponding to the plurality of medical care items included in the extracted display item group based on the plurality of medical care information sets.

A medical care information display control program of the present invention causes a computer to function as:

a target period obtaining unit that obtains a target period;

a medical care information obtaining unit that obtains a plurality of medical care information sets, each correlating a plurality of medical care items, medical care data of a display target patient corresponding to each medical care item, and a registration reference time of the medical care data, and obtains, among the plurality of medical care information sets, a plurality of medical care information sets whose registration reference times fall within the target period as target medical care information;

an item group extraction unit that obtains a plurality of medical care item groups, each correlating a plurality of medical care items to be displayed on a display screen and, from the plurality of medical care item groups, extracts a medical care item group that includes a medical care item of interest which is a predetermined medical care item included in the target medical care information as a display item group; and

a display control unit that displays medical care data of the display target patient corresponding to the plurality of medical care items included in the extracted display item group based on the plurality of medical care information sets.

The “medical care information” described above may be any information as long as it correlates a medical care item, medical care data corresponding to the medical care item, and the registration reference date of the medical care data. For example, the medical care information may include, by way of example, test information, such as sample test information, imaging test information, and the like, treatment information, such as medication information and the like, diagnostic information, such as an electronic medical record or discharge summary in which diagnostic information, such as the diagnosis, symptom, surgical treatment of the display target patient is recorded by the doctor, and biological information, such as the body temperature, blood pressure, respiratory rate, and the like of the display target patient. The imaging test information may be any information as long as it is test information using an image of the display target patient. For example, images obtained by various types of modalities, such as ultrasonic diagnostic equipment, CT equipment, MRI equipment, CR equipment, and the like and their image interpretation reports may be cited.

Further, the “registration reference time” as used herein may be expressed in any unit, including month, week, day, and time, and may be any predetermined time arbitrarily set with respect to each medical care item such as the time when the medical care data were obtained or the time that can be deemed in effect at which the medical care data were obtained. For example, it may be either when the medical data were inputted (or obtained) or when the medical data were updated last. For example, if it is an imaging test, the registration reference time may be the time when the image was obtained. If it is a sample test, the registration reference time may be the time when the sample test was conducted, if it is an electronic medical record, the registration reference time may be the time when the electronic medical record was created or the time when the record was updated last, if it is medication information, the registration reference time may be the time when the drug was prescribed, and if it is biological information, the registration reference time may be the time when the biological information was measured.

The “medical care item group” described above correlates a plurality of medical care items to be displayed on the display screen. It is a medical care item set that includes a plurality of medical care items which should be evaluated comprehensively in medical diagnosis. It is preferable that the medical care item group includes medical care items properly selected and correlated based on any arbitrary medical view point. For example, it is conceivable that the medical care item group includes, with respect to each disease, a plurality of correlated medical care items used for diagnosis of each disease. Further, the medical care item group may include, with respect to each symptom (or syndrome of related symptoms), a plurality of correlated medical care items used for diagnosis of each symptom (or syndrome).

Further, the “medical care item of interest” may be one or more medical care items arbitrarily set from the medical care items. It is preferable that a medical care item which should be noted in diagnosis, such as a medical care item that shows a known sign for a give disease, is set as the medical care item of interest. For example, the medical care item of interest may be a medical care item whose medical care data show an abnormal value and/or a medical care item whose medical care data have a variation which is greater than or equal to a predetermined threshold value among the medical care items of the target medical care information.

The “a medical care item group that includes a medical care item of interest” may be any medical care item group that includes at least one medical care item of interest and not necessarily includes all medical care items of interest.

The “target period” described above may be any period and it is preferable that a period which is highly likely to include noteworthy medical care information of the display target patient is properly selected and set as the “target period”. The target period obtaining unit may obtain the target period by any method. For example, the target period obtaining unit may use any graphical user interface (GUI) and receive an input of period from an input unit such as a mouse, a keyboard, or a touch panel.

In the medical care information display control apparatus according to the present invention, the target period obtaining unit may be configured to obtain period related information that correlates an assumed disease, a diagnosis and treatment department, and a predetermined reference period in advance to obtain the assumed disease of the display target patient and the diagnosis and treatment department that refers to the display screen, and to obtain a predetermined reference period according to the assumed disease of the display target patient and the diagnosis and treatment department that refers to the display screen as the target period based on the period related information.

The “assumed disease of the display target patient” may be assumed by any method and, for example, a disease extracted from diagnostic information, such as an electronic medical record or a discharge summary included in the medical care information may be used as the assumed disease for determining the period by the target period obtaining unit. Further, a disease assumed by any technique from the medical care information of the display target patient, such as past test results and the like, may be used as the assumed disease. The “the diagnosis and treatment department that refers to the display screen” may be any information that identifies the diagnosis and treatment department, such as internal medicine, cardiovascular department, and the like. Further, the diagnosis and treatment department may be obtained by any method. From the ID of a diagnosis and treatment department terminal, the diagnosis and treatment department to which the diagnosis and treatment department terminal belongs may be obtained as the diagnosis and treatment department. Otherwise, the diagnosis and treatment department may be obtained from the information of the user logged in the diagnosis and treatment department terminal or by receiving a manual input from the input unit, such as a mouse or a keyboard.

Further, in the medical care information display control apparatus according to the present invention, the target period obtaining unit may be configured to obtain a further period related information that correlates a period determining medical care item group in which a plurality of predetermined medical care items is correlated and a predetermined reference period, to obtain a medical care item whose medical care data show an abnormal value or a medical care item whose medical care data have a variation which is greater than or equal to a predetermined threshold value with the latest registration reference time among the medical care items included in the plurality of medical care information sets of the display target patient as a latest medical care item, and to obtain the reference period corresponding to the period determining medical care item group that includes the latest medical care item as the target period based on the further period related information.

The “predetermined reference period” described above may be a predetermined reference period defined by any method, as long as a predetermined period can be identified. For example, the reference period may be defined by the start time (or end time) of the reference period and a predetermined period. For example, the month which includes the registration reference date of the medical care data corresponding to the latest medical care item is set as a reference month and a period of one year before and after the reference month may be defined as the reference period in the further period related information or the current date is set as a reference time (reference date) and a period of past six months from the reference date may be defined as the reference period. Otherwise, the oldest date of the registration reference dates of the medical care data of the same medical care item may be defined as the start time and the registration reference date of the latest medical care item may be defined as the end time.

It is preferable that the “period determining medical care item group” described above includes a plurality of medical care items which brings forth a known characteristic result based on a similar or identical cause in medical diagnosis properly selected and correlated based on any arbitrary medical view point. For example, it is conceivable that the period determining medical care item group is constituted by a plurality of medical care items, with respect to each disease, selected from a plurality of medical care items that shows an abnormal value or a medical care item whose medical care data have a variation greater than or equal to a predetermined threshold value in the case of the disease. As an example, the period determining medical care item group may be constituted by AST (aspartate aminotransferase) and ALT (alanine aminotransferase) which are medical care items that show a sign of liver impairment, and the reference period corresponding to the period determining medical care item group of AST and ALT may be a period with the latest registration reference time at which the medical care data of both AST and ALT showed abnormal values as the last day and the date back to the past by a predetermined number of days from the last day as the start date. Further, the period determining medical care item group may be constituted, with respect to each symptom (or each syndrome of related symptoms), by any combination of a plurality of medical care items selected from the medical care items that show an abnormal value in the case of the symptom (or syndrome) and medical care items which are highly likely to vary largely within a predetermined period in the case of the disease.

Further, in the medical care information display control apparatus according to the present invention, a configuration may be adopted in which, if a plurality of medical care item groups that includes a medical care item of interest is extracted, the item group extraction unit calculates a priority for each of the medical care item groups, the display control unit displays the plurality of medical care item groups as display item group candidates on the display screen with the calculated priorities being represented in a visually recognizable manner, and the item group extraction unit obtains a specification of a display item group candidate displayed on the display screen and extracts the obtained display item group candidate as the display item group.

In the context of “displays the plurality of medical care item groups as display item group candidates on the display screen with the calculated priorities being represented in a visually recognizable manner” the method may be any display method as long as it allows the priority of each of the plurality of display item groups to be understandable. For example, the plurality of display item groups may be sorted in the order of priority and display item group names may be displayed in the descending order of priority, in which display item group names may be displayed by changing the degree of emphasis by changing the size or color of the character according to the priority or a numerical value or an index representing the priority may be displayed with respect to each display item group name.

Further, in the medical care information display control apparatus according to the present invention, if the item group extraction unit calculates a priority for each medical care item group candidate, it is preferable that the item group extraction unit calculates the priority for each medical care item group candidate by weighting such that the higher the matching between the medical care items included in the medical care item group candidate and the medical care items included in the target medical care information, the higher the priority.

Further, in the present invention, if the item group extraction unit calculates a priority for each medical care item group candidate, it is preferable that the item group extraction unit calculates the priority by weighting such that the higher the matching between the medical care items included in the medical care item group candidate and the medical care items whose medical care data show abnormal values and/or the medical care items whose medical care data have variations greater than or equal to a predetermined threshold value among the medical care items of the target medical care information, the higher the priority.

In the context of “medical care item whose medical care data show an abnormal value” described above, it is preferable that, for each medical care item, a value representing that the value of the medical care data is in an attentive level is properly set to the abnormal value based on the knowledge of medical diagnosis. The absolute value of difference between a medical care data value and standard value may be determined as the abnormal value if it is greater than a predetermined threshold value. Otherwise, a normal range and an abnormal range may be defined and a medical care data value included in the abnormal range may be determined as an abnormal value. Further, in a positive negative test, medical care data that show positive may be determined as an abnormal value. Still further, when determining “a medical care item whose medical care data show an abnormal value”, it is conceivable, for example, that the medical care information obtaining unit obtains discrimination information that correlates an abnormal value range of medical care data and each medical care item in advance, and based on the discrimination information, extracts medical care information having an abnormal value from a plurality of medical care information sets, and a medical care item of the extracted medical care information is obtained as the medical care item whose medical care data show an abnormal value. Further, different abnormal numerical ranges may be used for different diseases and, in this case, it is conceivable, for example, that an assumed disease of the display target patient is obtained and a different abnormal numerical range is applied to the medical care data of the display target patient according to the assumed disease.

In the aforementioned description “a medical care item whose medical care data have a variation which is greater than or equal to a predetermined threshold value”, it is preferable that an appropriate variation during an appropriate period that allows the medical care data to be evaluated as showing an attentive variation is set as the predetermined threshold value based on the knowledge of medical diagnosis for each medical care item. For example, it is conceivable that the absolute value of difference in the value of biological information during a predetermined period, the absolute value of difference in the value of sample test during a predetermined period, or the absolute value of difference in the size (value indicating long diameter, area, or volume) of lesion area of image data during a predetermined period is used as the variation in the medical care data. Further, when determining “a medical care item whose medical care data have variation which is greater than or equal to a predetermined threshold value”, it is conceivable, for example, that the medical care information obtaining unit obtains threshold value information in which a predetermined threshold value for judging that a variation in medical care data during a predetermined period is an attentive level is related to each medical care item, then based on the obtained threshold value information, extracts a medical care item whose variation in the medical care data is greater than or equal to a predetermined threshold value from a plurality of medical care information sets, and a medical care item of the extracted medical care information is obtained as the medical care item whose medical care data have a variation greater than or equal to a predetermined threshold value. Further, different variation threshold values may be applied to medical care data of the display target patient for different diseases and, in this case, it is conceivable, for example, that an assumed disease of the display target patient is obtained and a different variation threshold value is applied to the medical care data of the display target patient according to the assumed disease.

The medical care information display control apparatus, method, and program of the present invention, a target period is obtained, a plurality of medical care information sets, each correlating a plurality of medical care items, medical care data of a display target patient corresponding to each medical care item, and a registration reference time of the medical care data, is obtained, then among the plurality of medical care information sets, a plurality of medical care information sets whose registration reference times fall within the target period is obtained as target medical care information, a plurality of medical care item groups, each correlating a plurality of medical care items to be displayed on a display screen is obtained from the plurality of medical care item groups, a medical care item group that includes a medical care item of interest which is a predetermined medical care item included in the target medical care information is extracted as a display item group, and medical care data of the display target patient corresponding to the plurality of medical care items included in the extracted display item group are displayed based on the plurality of medical care information sets. This allows a display item group to be extracted appropriately from a medical care item group that properly correlates predetermined medical care items to be referenced in combination, and medical care data corresponding to each of a plurality of medical care items which is effective when considered comprehensively to be displayed appropriately based on the extracted display item group. This may reduce the overlooking of medical care data which should be noted in diagnosis and may assist the doctors and the like in improving the diagnostic accuracy and diagnostic efficiency.

### BRIEF DESCRIPTION OF THE DRAWINGS

FIG. 1 is a block diagram of a medical information system using an embodiment of the medical care information display control apparatus of the present invention, illustrating a schematic configuration thereof.

FIG. 2A illustrates, by way of example, a medical care information display control screen when a target period is obtained.

FIG. 2B illustrates, by way of example, a medical care information display control screen when a display item group is specified.

FIG. 2C illustrates, by way of example, a medical care information display control screen displayed according to the display item group.

FIG. 3 is a flowchart for explaining the processing flow of the medical information system using an embodiment of the medical care information display control apparatus of the present invention.

### DESCRIPTION OF THE PREFERRED EMBODIMENTS

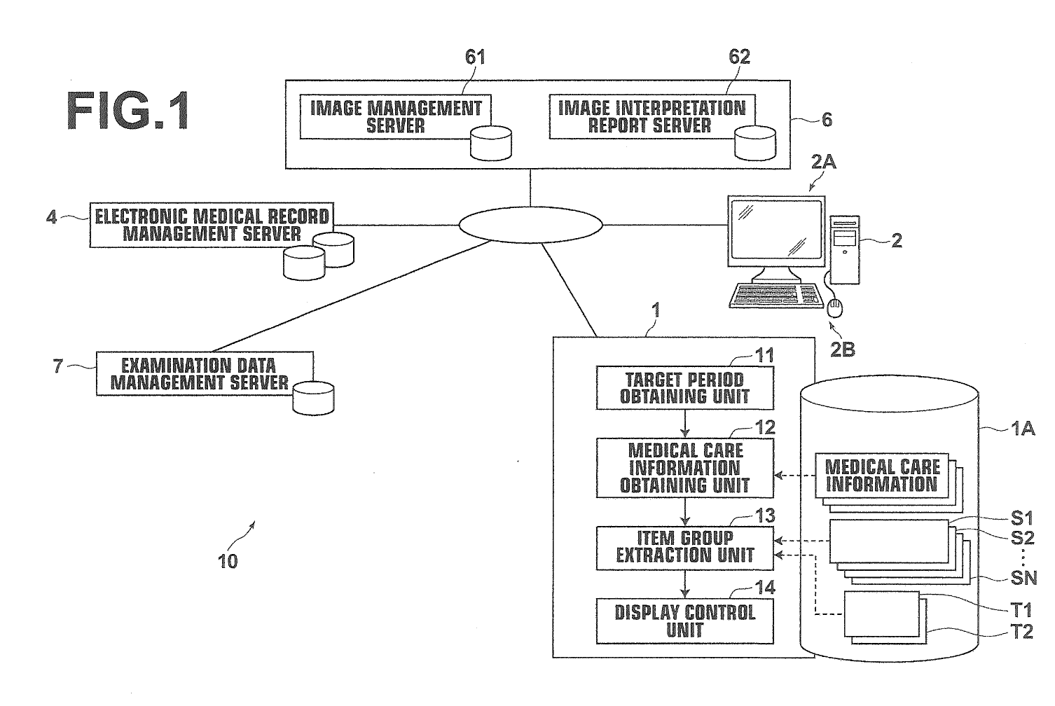

Hereinafter, an embodiment of the medical care information display control apparatus of the present invention will be described based on FIG. 1, FIG. 1 is a drawing illustrating a schematic configuration of a medical information system to which the medical care information display control apparatus according to a first embodiment of the present invention is applied and is a functional block diagram of the medical care information display control apparatus of an embodiment of the present invention.

As illustrated in FIG. 1, a medical information system 10 includes a medical care information display control apparatus 1, a diagnosis and treatment department terminal 2, an electronic medical record management server 4, an image diagnosis system 6, and an examination data management server 7 which are communicatively connected via a network.

The electronic medical record management server 4 is a computer provided with an electronic medical record database which stores electronic medical records, and includes software for retrieving medical care information, such as an image associated with each electronic medical record, test results, or the like, and performing transmission/reception of retrieval results in response to a request from the diagnosis and treatment department terminal 2 or the like, in addition to an operating system and database management software. The electronic medical record management server 4 is connected to the medical care information display control apparatus 1, the diagnosis and treatment department terminal 2, the examination data management server 7, the image diagnosis system 6, and the like via a network so as to be able to obtain each medical care information set associated with electronic medical records.

The examination data management server 7 is a computer provided with an examination data management database which stores test data, and includes examination data management software in addition to standard software, such as an operating system. Sample test information that includes test date of a sample test performed in the test room according to a test order inputted from each diagnosis and treatment department terminal 2, and test result data are inputted associated with the test order and the patient ID from a test room terminal (not shown) provided in each test room and stored in the examination data management database via a network.

The image diagnosis system 6 is a known computer system. Here, it is of a configuration in which a workstation (not shown) for image diagnostic doctors, modalities (not shown), such as CT, MRI, and the like, an image management server 61 provided with an image database which stores image data obtained by the modalities, such as CT, MRI, and the like, and an image interpretation report server 62 provided with an image interpretation report database which stores image interpretation reports, including image interpretation results of the images obtained by the imaging, are communicatively connected via a network. The workstation for image diagnostic doctors includes various types of image analysis software and is configured so as to be able to perform various types of image analysis processing according to the purpose and target of the diagnosis.

The diagnosis and treatment department terminal 2 is a computer used by the doctors of diagnosis and treatment department and the like for viewing medical care information of a patient and inputting a test order, and the like, and includes a display unit 2A which is a common display and an input unit 2B which includes a keyboard and a mouse. The diagnosis and treatment department terminal 2 is also used for displaying result data of a test performed in each diagnosis and treatment department or medical care information, such as a generated electronic medical record, for reference. The diagnosis and treatment department terminal 2 includes standard software, such as an operation system, and application software for displaying medical care information, such as a generated electronic medical record.

In the present embodiment, when an instruction operation to start display medical care information and a specification (or input) operation of necessary information, such as the patient ID, made by the user, such as a doctor, are received by the input unit 2B, such as a mouse or a keyboard, of the diagnosis and treatment department terminal 2, and various instructions for displaying medical care information and required information according to the various instructions are inputted by the input unit 2B, the diagnosis and treatment department terminal 2 transmits the various instructions and data corresponding to the various instructions, as required, to the medical care information display control apparatus 1, to be described later. The medical care information display control apparatus 1 receives these various instructions (and corresponding data, as required) and transmits information required to display medical care information of the present embodiment, such as display setting information that defines the display setting and a plurality of medical care information sets corresponding to the inputted patient ID, and the like, to the diagnosis and treatment department terminal 2. The, the diagnosis and treatment department terminal 2 receives the display setting information and required information, and displays a medical care information display screen, to be described later, on the display screen of the display unit 2A based on the received display setting information and required information.

The medical care information display control apparatus 1 is a computer provided with a medical care information management database 1A. Further, the medical care information display control apparatus 1 includes an operating system and database management software and functions also as a medical care information management server. The medical care information display control apparatus 1 is connected to the electronic medical record management server 4, the diagnosis and treatment department terminal 2, the examination data management server 7, the image management server 61, and the image interpretation report server 62 via a network, and retrieves and obtains medical care information of a patient, such as the electronic medical record of the patient, various test result data, image data, image interpretation report, and the like, from each of the connected servers or the like based on the patient ID, and stores the medical care information in the medical care information management server 1A after associating the information with the patient ID. In the medical care information, each medical care information set included in the medical care information is associated with a registration reference time (registration reference date) and stored. The medical care information display control apparatus 1 updates the medical care information to be managed at a fixed time every day. Further, the medical care information display control apparatus 1 receives, as appropriate, medical care information transmitted from each of the servers or the like and updates the medical care information to be managed in response to a request from each of the servers or the like. Still further, the medical care information display control apparatus 1 obtains medical care information from each of the servers or the like and updates the medical care information to be managed as required by the medical care information display control apparatus 1.

The medical care information display control apparatus 1 of the present embodiment includes a medical care information display control program according to the present embodiment. By the execution of the medical care information display control program, the medical care information display control apparatus 1 functions as a target period obtaining unit 11 that obtains a target period, a medical care information obtaining unit 12 that obtains a plurality of medical care information sets, each correlating a plurality of medical care items, medical care data of a display target patient corresponding to each medical care item, and a registration reference time of the medical care data and, obtains, among the plurality of medical care information sets, a plurality of medical care information sets whose registration reference times fall within the target period as target medical care information, an item group extraction unit 13 that obtains a plurality of medical care item groups, each correlating a plurality of medical care items to be displayed on a display screen and, from the plurality of medical care item groups, extracts a medical care item group that includes a medical care item of interest which is a predetermined medical care item included in the target medical care information as a display item group, and a display control unit 14 that displays medical care data of the display target patient corresponding to the plurality of medical care items included in the extracted display item group based on the plurality of medical care information sets.

The medical care information management database 1A of the medical care information display control apparatus 1 also includes display setting information required to display a plurality of medical care information sets on the diagnosis and treatment department terminal 2 in a predetermined display format. Further, N medical care item groups S1 to SN (medical care item sets) are created with respect to each disease by the doctors and the like by selecting and correlating a plurality of medical care items which should be evaluated comprehensively in medical diagnosis according to each disease and stored in the medical care information management database 1A. Still further, discrimination information T1 that correlates an abnormal value range of medical care data and each medical care item, and threshold value information T2 that correlates a predetermined threshold value for judging that a variation in medical care data during a predetermined period is an attentive level and each medical care item, are created in advance based on the knowledge of medical diagnosis and stored in the medical care information management database 1A of the medical care information display control apparatus 1.

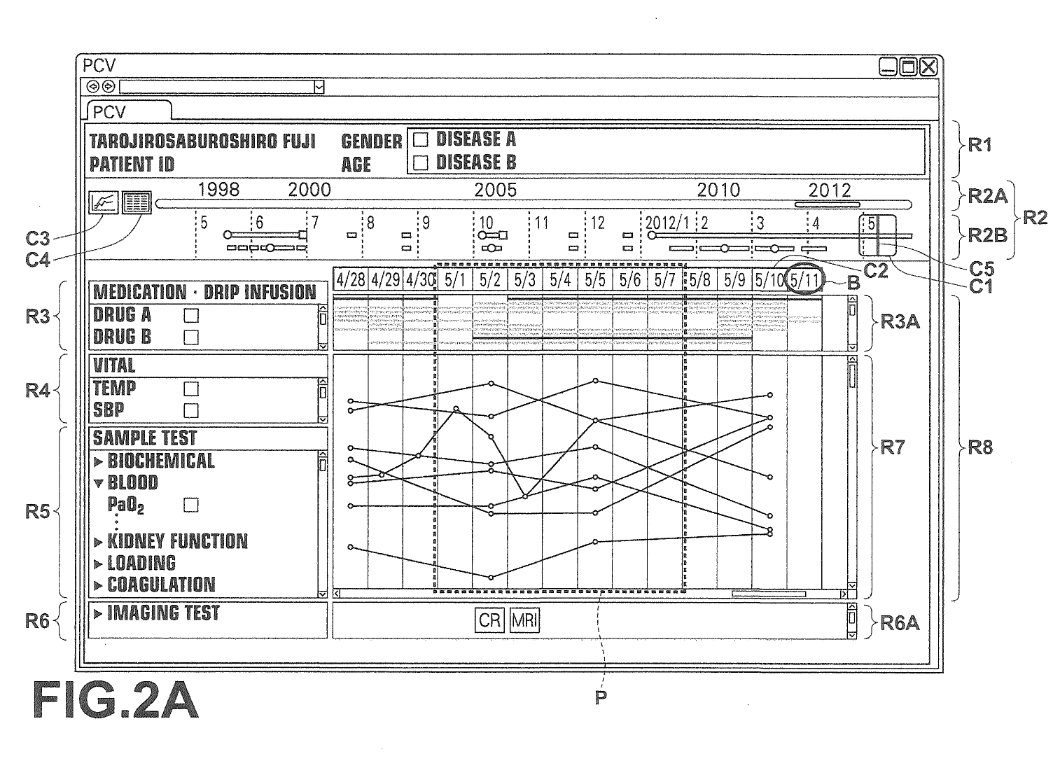

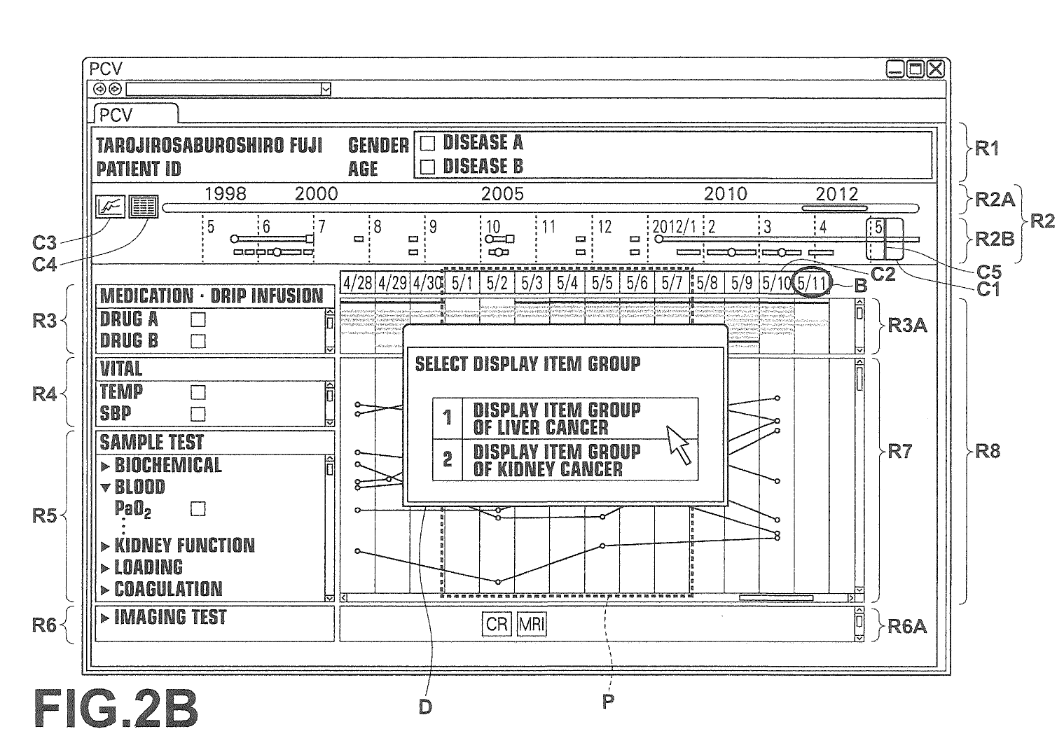

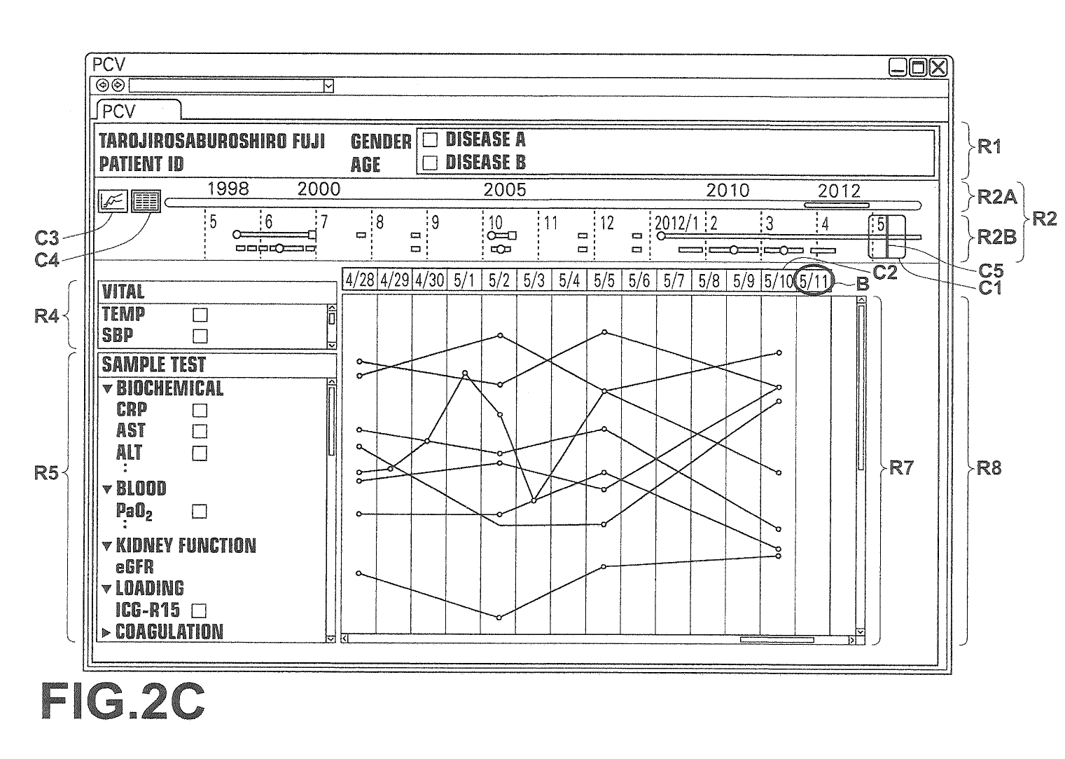

A medical care information display screen display controlled by the medical care information display control apparatus 1 will now be described. FIG. 2A illustrates an example initial display screen displayed on the diagnosis and treatment department terminal 2 through control of the medical care information display control apparatus of the present embodiment, which is an example in which all medical care information with respect to each medical care item of a display target patient within a predetermined details display period. Each section of the medical care display screen will be described first using FIG. 2A. FIG. 2B illustrates an example of medical care information display control screen at the time of selecting a display item group displayed in the course of display control by the medical care information display control apparatus 1, and FIG. 2C illustrates an example of final medical care information display control screen displayed according to an extracted display item group, both of which will be described later.

As illustrated in FIG. 2A, the medical care information display screen includes a basic information display section R1, an examination period display section R2, a medication information display section R3, a medication data display section R3A, a biological information display section R4, a sample test information display section R5, and an image information display section R6, an image data display section R6A, and a graph display section R7 for graphically displaying each graphable medical care data set.

The basic information display section R1 is a section in which basic information is displayed, such as the identification information of a patient (patient ID), name, age, gender, disease, and the like. The disease is obtained by extracting a disease described in an electronic medical record or a discharge summary.

The examination period display section R2 is a region representing a time axis. As illustrated in FIG. 2A, the upper portion R2A of the examination period display section R2 indicates the time axis with the numbers representing Christian years and a scale. Here, the time axis is set to include the period in which medical care data of a patient are present and a predetermined additional period. If the period in which medical care data of a patient are present is shorter than a predetermined period as in a new patient or the like, the time axis is set so as to indicate a predetermined initial period.

The lower portion R2B of the examination period display section R2 indicates the presence of medical care information in the past one year, including the current date, and a rectangular index representing the presence of medical care data is displayed at the position corresponding to each registration reference time of medical care data along the time axis. Further, the examination period display section R2 includes a red line C5 representing the current date (FIG. 2A is an example in which May 11, 2012 is set as the current date) displayed at the position corresponding to the current date. Further, a circular index is displayed at the position corresponding to the date of admission and a white square index is displayed at the position corresponding to the date of discharge. Further, the examination period display section R2 includes a rectangular index C1 displayed at the position corresponding to the details display period (period corresponding to the time axis C2 of the medial care data display section R8, to be described later) whose detailed medical care data are shown in the medical care data display section R8 among the periods displayed in the lower portion R2B.

The medication information display section R3 displays a type of drug administered or infused into the display target patient (medical care item). Further, a medication data display section R3A which shows a period of medication or drip infusion to the patient is provided adjacent to the medication information display section R3, and a period of medication or drip infusion received by the patient is shown by a horizontal bar graph in the medication data display section R3A.

The biological information display section R4 displays a biological information item of the patient (medical care item). The biological data (medical care data) corresponding to each biological information item in the biological information display section R4 are graphically displayed in the graph display section R7 by a line graph with respect to each biological information item of the patient according to the measurement data (registration reference time of the biological information. The horizontal axis of the graph display section R7 is the time axis and the vertical axis is the axis that indicates numerical values of each set of medical care data, such as the data of biological information, sample test data, and the like. The data that indicate an abnormal value among the biological data are identifiably displayed in red.

The sample test information display section R5 displays a sample test item (medical care item) of the subject. The sample test data (medical care data) corresponding to each sample test item displayed in the sample test information display section R5 are graphically displayed in the graph display section R7 by a line graph according to the test date (registration reference time) of each set of test result data. Each medical care item included in sample test information is further classified into a test middle category, such as biochemical test, blood test, kidney function test, loading test, coagulation test, or the like, and each middle category is further classified into a test small category. Further, the data that indicate an abnormal value among the sample test data are identifiably displayed in red.

The image information display section R6 displays imaging test information of the patient, and title characters are displayed here. Further, an image data display section R6A is provided adjacent to the image information display section R6, and a thumbnail image obtained by imaging the patient with CR or MRI is displayed at the position corresponding to the imaged date (registration reference time) of the image in the image data display section R6A. When the thumbnail image is selected, for example, by clicking or the like, the original image corresponding to the thumbnail image is displayed on a separate display screen with an image interpretation report of the original image.

The medication data display section R3A, the graph display section R7, and the image data display section R6A constitute a medical care data display section R8 in which medical care data of a plurality of medical care items of the patient included in the details display period indicated on the time axis C2 are displayed in time series. If the current date is included in the details period, as illustrated by an ellipse B, the current date is identifiably displayed. Further, any period may be set as the details display period according to a user request. In the medical care information display screen, the medical care data displayed in the medical care data display section R8 can be switched between a tabular form and a graph form and if a tabular form display button C4 located on the upper left of the display screen is selected, the tabular form display is applied and if a graph form display button C3 located on the upper left of the display screen is selected, the graph form display is applied.

In the medication information display section R3, the biological information display section R4, and the sample test information display section R5, each medical care item is list-displayed and a checkbox is displayed for each test item. Then, medical care data of the medical care item whose checkbox is checked are highlighted in the medical care data display section R8. More specifically, the medical care data of the medical care item whose checkbox is checked are, for example, color-displayed while the medical care data of a medical care item whose checkbox is not checked are displayed in a pale grey so as to be less noticeable. Further, each medical care item in the medication information display section R3, the biological information display section R4, and the sample test information display section R5, is displayed in a displayable range according to the predetermined display screen size and all medical care items may be confirmed by moving the scroll bar up and down.

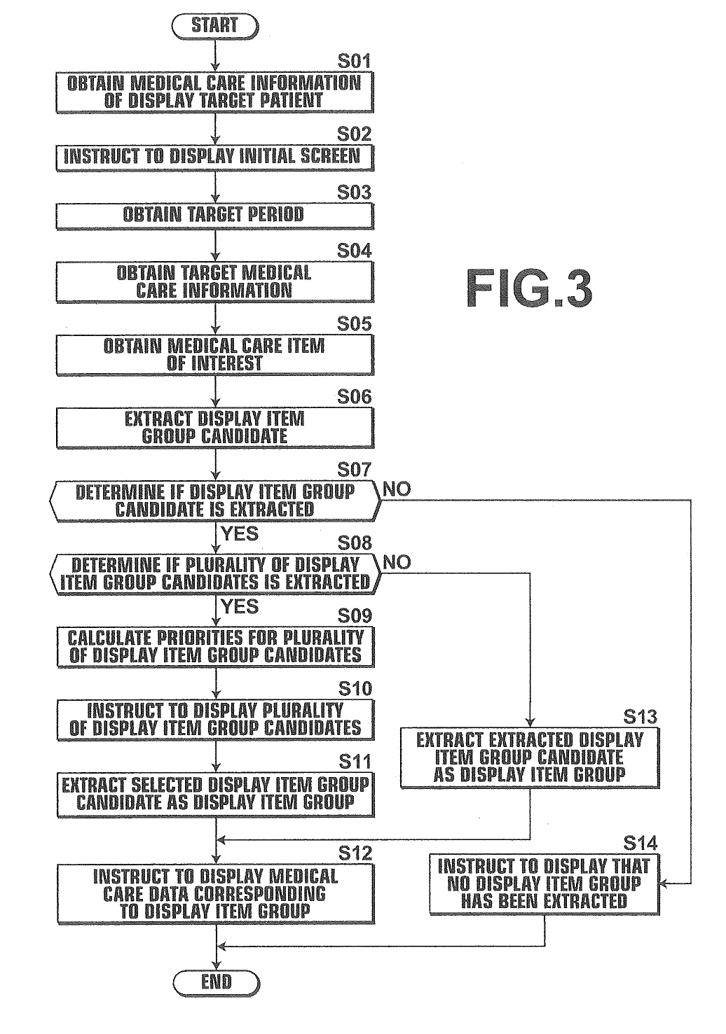

FIG. 3 is a flowchart describing the processing flow of the medical care information display control apparatus 1 according to the first embodiment. The processing flow of the medical care information display control apparatus 1 according to the first embodiment will be described based on FIG. 3.

First, in the diagnosis and treatment department terminal 2, when an instruction to display medical care information according to the present embodiment and a patient ID of a display target patient are inputted by the input unit 25 based on an operation of the user, such as a doctor or the like, the diagnosis and treatment department terminal 2 transmits the inputted patient ID and the instruction to start displaying medical care information to the medical care information display control apparatus 1. Then, the medical care information display control apparatus 1 receives the patient ID and the instruction to start displaying medical care information, and executes the medical care information display processing according to the present embodiment.

First, the medical care information obtaining unit 12 obtains the patient ID transmitted from the diagnosis and treatment department terminal 2 and obtains a plurality of medical care information sets corresponding to the patient ID from the medical care information management database 1A (S01). Further, the medical care information display control apparatus 1 transmits an instruction to display the basic information display section R1 and information necessary for the display to the diagnosis and treatment department terminal 2 based on display setting information for displaying the medical care information and a plurality of obtained medical care information sets. Then, based on the display setting information, a medical care information display screen is displayed on the display section 2A of the diagnosis and treatment department terminal 2 and the basic information of the patient is displayed in the basic information display section R1.

Further, in each embodiment described herein, the medical care information obtaining unit 12 obtains, based on the patient ID, all medical care information sets related to the patient ID from the medical care information management database 1A. Here, it is assumed that diagnostic information, such as an electronic medical record, imaging test information, sample test information, biological information, and treatment information are obtained.

Then, the display control unit 14 obtains, based on the plurality of obtained medical care information sets, a registration reference time of each set of medical care data included in the plurality of medical care information sets, and calculates an entire medical care period with the oldest date among the plurality of obtained registration reference times as the start date and the latest date among the plurality of obtained registration reference times as the end date. Then, the display control unit 14 determines the entire medical care period as the period of the time axis on the upper portion R2A of the examination period display section R2. Further, the display control unit 14 determines a predetermined past display period (about one year) from the current date as the period of the time axis on the lower portion R2B. Then, the display control unit 14 displays the examination period display section R2 in a predetermined display form according to the determined display period of each time axis and determines, as the details display period, a predetermined period with the current date as the end date. Then, the display control unit 14 extracts medication information, biological information, sample test information, and image information of the display target patient present within the details display period as the medical care information displayed in detail in each section of the medication information display section R3, the biological information display section R4, the sample test information display section R5, the image information display section R6, and the medical care data display section R8.

Then, based on the determined period of each time axis of the examination period display section R2 and extracted each set of medical care information, the display control unit 14 issues an instruction to display the medical care information display screen shown in FIG. 2A on a display unit (S02). Here, the display control unit 14 transmits necessary data, such as the determined period of each time axis of the examination period display section R2 and each extracted medical care information set, and the like, and the display instruction to the diagnosis and treatment department terminal 2. Then, the examination period display section R2 shown in FIG. 2A is displayed on the display screen of the diagnosis and treatment department terminal 2.

Next, when an area P is specified within the medical care information display screen shown in FIG. 2A by the input unit 2B of the diagnosis and treatment department terminal 2 based on a user operation by a drag and drop operation along the time axis C2 of the medical care data display section R8, the diagnosis and treatment department terminal 2 receives the positions of the start and end points of the inputted area P and transmits to the medical care information display control apparatus 1. Then, based on the relative positions between the positions of the start and end points and the time axis of the medical care data display section R8, the target period obtaining unit 11 obtains a period with the older date of those corresponding to the start and end points as the start date and the newer date thereof as the end date as the target period for extracting a medical care item group (S03).

Next, the item group extraction unit 13 identifies a plurality of medical care information sets whose registration reference dates are included in the target period from the past medical care information of the patient and obtains as the target medical care information (S04).

In the present embodiment, the item group extraction unit 13 obtains discrimination information T1 that correlates an abnormal value range of medical care data and each of a plurality of medical care items and threshold value information T2 that correlates a predetermined threshold value for judging that a variation (absolute value of difference in the medical care data) in medical care data during a predetermined period is an attentive level and each medical care item from the medical care information management database 1A, and based on the obtained discrimination information T1 and threshold value information T2, obtains a medical care item whose medical care data show an abnormal value and a medical care item whose variation in the medical care data is greater than or equal to a predetermined threshold value from the medical care items of the target medical care information as medical care items of interest (S05). Here, it is assumed that AST (aspartate aminotransferase) and ALT (alanine aminotransferase) are extracted as the medical care items of interest.

Then, with respect to each disease, the item group extraction unit 13 obtains medical care item groups S1 to SN, each correlating a plurality of medical care items to be displayed on the display screen, from the medical care information management database 1A, and extracts a medical care item group which includes at least one medical care item of interest which is a predetermined medical care item included in the target medical care information from the obtained N medical care item groups as a display item group candidate (S06).

Table 1 predetermined below shows, by way of example, a medical care item group of liver cancer, a medical care item group of pneumonia, and a medical care item group of kidney cancer which are the medical care item groups of the present embodiment. Table 1 relates Y (Yes) or N (No) to each medical care item to indicate whether or not each medical care item is displayed with respect to each disease, and the medical care item group of liver cancer is the group of medical care items indicated as Y in the liver cancer column in Table 1. Likewise, the medical care item group of pneumonia is the group of medical care items indicated as Y in the pneumonia column in Tabel 1 (Tables 1A and 1B), and the medical care item group of kidney cancer is the group of medical care items indicated as Y in the kidney cancer column in Table 1. For example, it is assumed that the two groups, the medical care item group of liver cancer and the medical care item group of kidney cancer which are medical care item groups that include at least one of AST and ALT which are the medical care items of interest are extracted as the display item group candidates.

TABLE 1A

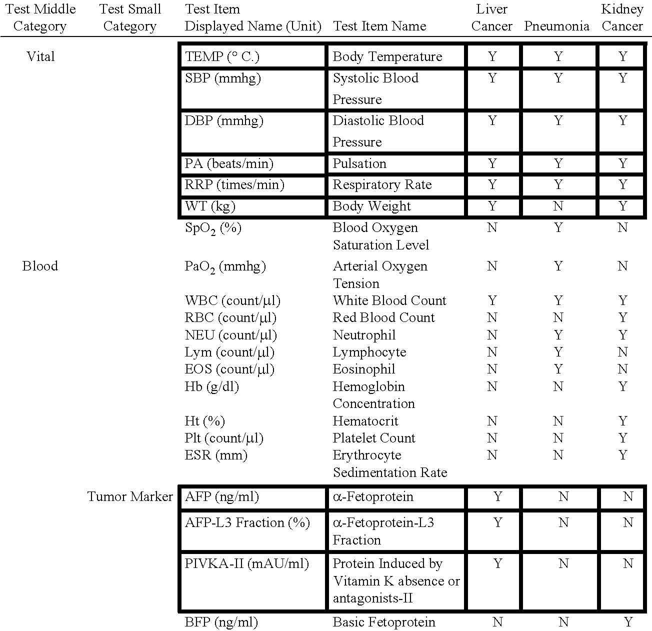

TABLE 1B

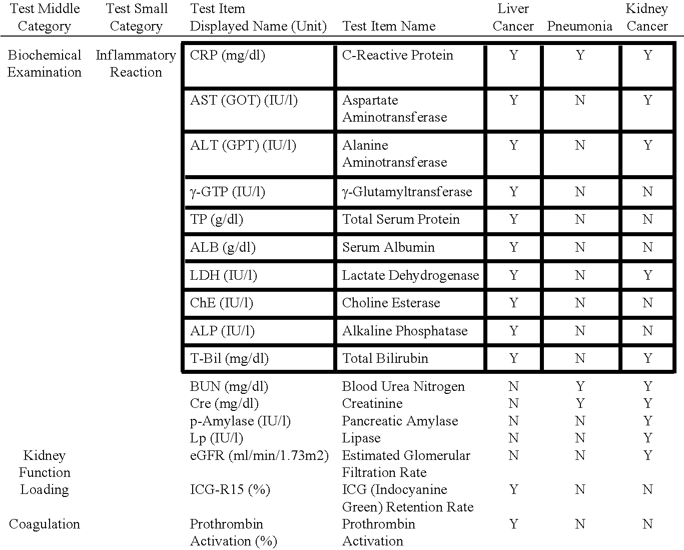

The item group extraction unit 13 determines whether or not more than one display item group is present, and if one display item group is extracted (S07: Yes, S08: No), extracts the extracted medical care item group as the display item group (S13). If no display item group is extracted (S07: No), the display control unit 14 transmits an instruction to display a dialog notifying that no display item group has been extracted on the display screen to the diagnosis and treatment department terminal 2 (S14).

In the mean time, if a plurality of medical care item groups is extracted (S07: Yes, S08: Yes), the item group extraction unit 13 calculates a priority for each display item group candidate (S09).

In the present embodiment, the item group extraction unit 13 calculates a score weighted such that the higher the matching between the medical care items included in the display item group candidate and the medical care items included in the target period, the higher the priority. Here, it is assumed that the greater the numerical value of the score, the higher the priority, but the score may be set such that the lower the numerical value of the score, the higher the priority.

Here, if it is assumed, in Table 1, that the medical care items indicated by bold lines are medical care items included in the target medical care information, the number corresponding to the medical care items included in the medical care information is 19 for the medical care item group of liver cancer and 11 for the medical care item group of kidney cancer, so that the score of the medical care item group of liver cancer is calculated as 19 while the score of the medical care item group of kidney cancer is calculated as 11.

Next, the display control unit 14 transmits an instruction to selectably list-display the two display item group candidates on the display screen by sorting them in the descending order of priority (descending order of score) in a predetermined form and necessary information to the diagnosis and treatment department terminal 2 (S10). Then, as illustrated in FIG. 2B, the diagnosis and treatment department terminal 2 displays a selection dialog D on the display screen of the diagnosis and treatment department terminal 2 for prompting selection of a display item group candidate.

If the user selects a desired display item group candidate by the selection dialog D in FIG. 2B, the diagnosis and treatment department terminal 2 receives the selection and transmits the selected display item group candidate to the medical care information display control apparatus 1. Then, the item group extraction unit 13 extracts the selected display item group candidate as the display item group (S11). Here, it is assumed that the medical care item group of liver cancer is selected.

Next, the display control unit 14 identifies medical care information corresponding to a plurality of medical care items included in the extracted display item group from a plurality of medical care information sets of the target display patient within the details display period and transmits an instruction to display only the medical care data corresponding to the identified medical care information on the display screen and necessary data to the diagnosis and treatment department terminal 2 (S12). Then, as illustrated in FIG. 2C, the diagnosis and treatment department terminal 2 updates the medical care data display section R8 of the diagnosis and treatment department terminal 2 and displays only the medical care data corresponding to the medical care item group of liver cancer. Whereas all medical care information of each medical care item within the details display period (period indicated by the time axis C2 of the medical care data display section R8) are displayed in FIG. 2A, only the medical care data corresponding to the display item group of liver cancer among the medical care data within the details display period are displayed on the medical care information display screen.

According to the first embodiment, a medical care item group that includes a medical care item of interest is extracted as the display item group in the manner described above, and the medical care data of the display target patient corresponding to a plurality of medical care items included in the extracted display item group are displayed on the display screen. This allows a display item group to be extracted appropriately from medical care item groups in which predetermined medical care items which should be referenced in combination are properly related, and medical care data corresponding to each of a plurality of medical care items which is effective to be considered comprehensively to be displayed preferably based on the extracted display item group. This may reduce the overlooking of medical care data to be referenced in diagnosis and assist the doctors and the like in improving the diagnostic accuracy and diagnostic efficiency.

Further, if a plurality of display item group candidates is extracted, medical care data based on the display item group according to a user request may be displayed by displaying the extracted display item group candidates on the display screen, receiving a user selection of a display item group candidate, and extracting the selected display item group candidate as the display item group. Further, a priority is calculated for each of a plurality of display item group candidates and the each of the plurality of display item group candidates is displayed with the priority being represented in a visually recognizable manner, so that a selection guideline may be offered to the user.

Further, in the present embodiment, a medical care item group which includes a plurality of appropriately selected medical care items which should be evaluated comprehensively in medical diagnosis is set for each disease, so that a display item group candidate corresponding to a disease that should be watched out, such as a complicating disease, may be extracted appropriately. Further, as in the present embodiment, if the name of a display item group candidate is understandably displayed as to what disease (or symptom) the medial care item group corresponds to, the information that serves as clues of diseases that should be watched out, such as a complicating disease and the like, or symptoms may be offered to the doctors and the like, thereby the overlooking of medical care data may be reduced more appropriately.

Still further, as in the present embodiment, by setting a medical care item whose medical care data show an abnormal value and a medical care item whose medical care data have a variation which is greater than or equal to a predetermined threshold value as medical care items of interest, medical care items which should be noted in diagnosis may be determined appropriately and set as the medical care items of interest. Therefore, by extracting a display item group that includes a medical care item of interest, the medical care information that includes medical care data which should be noted in diagnosis may be displayed effectively.

Further, as in the present embodiment, if the priorities of display item group candidates are calculated by weighting such that the higher the matching between the medical care items included in the medical care item group candidate and the medical care items included in the target medical care information, the higher the priority, the possibility that a display item group that includes medical care items corresponding to the medical care items in the target period is increased.

Still further, as in the first embodiment, if a target period is obtained by receiving input from the input unit by a user operation of the doctor or the like, a period judged by the doctor or the like to include medical care data of interest may be set as the target period. Consequently, if a medical care item which should be noted in diagnosis is extracted appropriately from the target period, by extracting a display item group so as to include the medical care item of interest within the target period, the possibility that an appropriate display item group is extracted by leveraging judgments of the doctors and the like is increased and medical care data useful in diagnosis may be displayed appropriately based on the display item group.

As in the present embodiment, if a manual input of period is received and the received period is set as the target period, the input of period from the input unit such as a mouse or a keyboard may be received and the inputted period may be set as the target period by employing an arbitrary graphical user interface (GUI). For example, a numerical value of target period may be inputted directly in a dialog or the like from the keyboard or the target period may be selectively inputted by a drop-down list or the like.

In the mean time, the method of obtaining a target period for extracting medical care items is not limited to the first embodiment and any method may be employed.

For example, as a second embodiment, the target period obtaining unit 11 may obtain period related information T3 that correlates an assumed disease, a diagnosis and treatment department, and a predetermined reference period in advance to obtain the assumed disease of the display target patient and the diagnosis and treatment department that refers to the display screen, and set a predetermined reference period according to the assumed disease of the display target patient and the diagnosis and treatment department that refers to the display screen as the target period based on the period related information T3, in place of the processing corresponding to S03 of the first embodiment. Note that the second embodiment differs from the first embodiment only in the processing corresponding to S03 of the first embodiment, and the other processing, function and configuration of each unit are common to those of the first embodiment and are not described here.

In the second embodiment, period related information T3 that correlates an assumed disease, a diagnosis and treatment department, and a predetermined reference period is created and stored in the medical care information management database 1A in advance. The predetermined reference period in the period related information T3 is an appropriate period determined in advance according to the combination of the assumed disease and the diagnosis and treatment department. For example, even for the same disease, if the diagnosis and treatment department differs, the medical care item which should be noted in diagnosis or the follow-up period of a predetermined medical care item may possibly be different. Consequently, by property setting the target period so as to include a noteworthy medical care item according to the combination of the assumed disease and diagnosis and treatment department, the possibility that the medical care items included in the target period include a noteworthy medical care item is high and useful medical care data in diagnosis may be displayed appropriately based on the display item group.

In the aforementioned case, it is conceivable that the target period obtaining unit 11 may obtain the assumed disease of the display target patient from medical care information such as the past medical history or the like or by applying any arbitrary disease assuming technique on a plurality of past medical care information sets. If a plurality of diseases can be assumed, for example, a checkbox may be displayed on the display screen with respect to each disease name extracted from the electronic medical record or the discharge summary, as illustrated in FIG. 2A, and the disease whose checkbox is checked may be obtained as the assumed disease.

Further, a period related information T3A in which an assumed disease and a predetermined reference period are related is created by modifying the second embodiment and stored in the medical care information management database 1A in advance, then the period related information T3A is obtained to obtain an assumed disease of the display target patient, and a predetermine reference period according to the assumed disease of the display target patient may be set as the target period based on the period related information T3A. In this case, by properly setting the target period so as to include a noteworthy medical care item according to the disease, the possibility that the medical care items included in the target period include a noteworthy medical care item is increased and useful medical care data in diagnosis may be displayed appropriately based on the display item group.

Further, as a third embodiment, the target period obtaining unit 11 may obtain a further period related information T4 that correlates a period determining medical care item group in which a plurality of predetermined medical care items is correlated and a predetermined reference period to obtain a medical care item whose medical care data show an abnormal value or a medical care item whose medical care data have a variation which is greater than or equal to a predetermined threshold value with the latest registration reference time among the medical care items included in a plurality of medical care information sets as a latest medical care item and the reference period corresponding to the period determining medical care item group that includes the latest medical care item may be set as the target period based on the further period related information T4, in place of the processing corresponding to S03 of the first embodiment. Note that the third embodiment differs from the first embodiment only in the processing corresponding to S03 of the first embodiment, and the other processing, function and configuration of each unit are common to those of the first embodiment and are not described here.

The period determining medical care item group in the third embodiment may be formed of a combination of any number and various kinds of medical care items if it is a combination of a plurality of medical care items which brings forth a known characteristic result based on a similar or identical cause in medical diagnosis properly selected and correlated based on any arbitrary medical view point. It is preferable that the further period related information T4 includes, with respect to each period determining medical care item group, a properly set predetermined reference period corresponding to the viewpoint of the period determining medical care item group.

Here, it is assumed that the period determining medical care item group is constituted by a plurality of medical care items, with respect to each disease, selected from a plurality of medical care items that show abnormal values or medical care items whose medical care data have variations greater than or equal to a predetermined threshold value in the case of the disease. As an example, the period determining medical care item group corresponding to liver impairment may be constituted by AST (aspartate aminotransferase) and ALT (alanine aminotransferase) which are medical care items that show a sign of liver impairment. Further, in this case, it is preferable that an appropriate predetermined reference period according to the disease corresponding to the period determining medical care item group is set to the further period related information T4. Here, for example, the predetermined reference period of the period determining medical care item group corresponding to the liver impairment may be a period with the latest registration reference time at which the medical care data of both AST and ALT showed abnormal values as the last day and the date back to the past by a predetermined days from the last day as the start date.

In the third embodiment, the period determining medical care item group may be constituted, with respect to each symptom (or each syndrome of related symptoms), by any combination of a plurality of medical care items selected from the medical care items that show abnormal values in the case of the symptom (or syndrome) and medical care items which are highly likely to vary largely within a predetermined period in the case of the disease.

The medical care item whose medical care data show an abnormal value or the medical care item whose medical care data have a variation which is greater than or equal to a predetermined threshold value with the latest registration reference time among the medical care items included in a plurality of medical care information sets of the display target patient is highly likely the medical care information of the current display target patient to be medically noteworthy. According to the third embodiment, the latest medical care information can be obtained as the latest medical care item and the reference period corresponding to the period determining medical care item group that includes the latest medical care item can be obtained as the target period based on the further period related information T4. Therefore, it is highly likely that the target period that includes a noteworthy medical care item can be obtained appropriately and it is highly likely that a medical care item which should be note in diagnosis can be appropriately determined as the medical care item of interest from the target medical care information. Consequently, medical care data useful in diagnosis may be displayed appropriately based on the display item group that includes the medical care item of interest.

Further, as described in the third embodiment, if the period determining medical care item group is constituted by a plurality of medical care items, with respect to each disease, selected from a plurality of medical care items that show abnormal values or medical care items whose medical care data have variations greater than or equal to a predetermined threshold value in the case of the disease, and an appropriate reference period is related to the further period related information T4 according to the disease, an appropriate reference period according to the latest noteworthy medical care information may be obtained based on the period determining medical care item group and the possibility that the medical care item which should be noted in diagnosis can be determined properly as the medical care item of interest from the target medical care information is further increased.

The predetermined reference period in the period related information T3 in the second embodiment or in the further period related information T4 in the third embodiment is not limited to each embodiment described above and the predetermined period may be defined by any method as long as the predetermined period can be identified. For example, the reference period may be defined by the start and end times of the reference period, or the reference period may be defined by the start time (or end time) of the reference period and a predetermined period. In the further period related information T4, for example, a month which includes the registration reference date of the medical care data corresponding to the latest medical care item is set as a reference month and a period of one year before and after the reference month may be defined as the reference period or the current date is set as a reference date and a period of past six months from the reference date may be defined as the reference period. Further, the oldest date of the registration reference dates of the medical care data of the same medical care items as the latest medical care item may be defined as the start time and the registration reference date of the latest medical care item may be defined as the end time.

The medical care item of interest is not limited to each embodiment herein and one or more medical care items of those included in the target medical care information may be set arbitrarily. It is preferable that a medical care item which should be noted in diagnosis, such as a medical care item that shows a known sign for a predetermined disease, is set as the medical care item of interest. For example, all medical care items included in the target medical care information may be set as the medical care items of interest, only a medical care item whose medical care data show an abnormal value may be set as the medical care item of interest, or a medical care item whose medical care data have a variation which is greater than or equal to a predetermined threshold value may be set as the medical care item of interest. For example, with respect to each disease, a medical care item of interest related information which includes a predetermined medical care item known to show a known sign in the case of the disease correlated therein is created in advance and stored in the medical care information management database 1A or the like, then an assumed disease of the display target patient is obtained by a known method from the past medical care information of the display target patient, and a medical care item of interest according to the assumed disease may be determined based on the medical care item of interest related information. As the method for obtaining the assumed disease, a method that extracts a disease from the electronic medical record or discharge summary, or any method that extracts a disease based on a plurality of sets of medical care data may be applied.

The item group extraction unit 13 is not limited to each embodiment described above and, if a plurality of display item group candidates is extracted, any method for calculating priority may be employed. For example, a first priority condition is employed in the foregoing embodiments, but in place of this or in addition to this, a further priority condition may be used.

For example, the item group extraction unit 13 may calculate the priority based on a second priority condition in which weighting is implemented such that the greater the number of medical care items included in the medical care item group candidate that match with the medical care items whose medical care data show abnormal values and/or the medical care items whose medical care data have variations greater than or equal to a predetermined threshold value among medical care items of the target medical care information, the higher the priority. Further, the item group extraction unit 13 may calculate the priority based on a third priority condition in which an assumed disease is assumed based on the medical care items whose medical care data show abnormal values and/or the medical care items whose medical care data have variations greater than or equal to a predetermined threshold value among the target medical care items and weighting is implemented such that the display item group corresponding to the assumed disease is given a higher priority.

In the third priority condition, any disease assumption method may be applied for assuming the assumed disease and, for example, it is conceivable that, with respect to each disease, disease assumption information in which a medical care item whose medical care data are known to show an abnormal value in the case of the disease and a medical care item whose medical care data are known to show a variation greater than or equal to a predetermined threshold value in the case of the disease are correlated is provided in advance and stored in the medical care information management database 1A. Then, a medical care item whose medical care data show an abnormal value and/or a medical care item whose medical care data have a variation greater than or equal to a predetermined threshold value are obtained from the target medical care items and a disease related to the obtained medical care item is obtained as the assumed disease based on the disease assumption information.

If the priority is calculated using the second priority condition, the possibility that a display item group that includes a medical care item whose medical care data show an abnormal value and/or a medical care item whose medical care data have a variation greater than or equal to a predetermined threshold value may be increased. If the third priority condition is used, the possibility that the display item group corresponding to the assumed disease is extracted based on the medical care item whose medical care data show an abnormal value and/or the medical care item whose medical care data have a variation greater than or equal to a predetermined threshold value is increased. Further, if display item group candidates corresponding to the assumed disease are displayed, then a specification of a display item group candidate displayed on the display screen is obtained, and the obtained display item group candidate is extracted as the display item group, display item group candidates according to the assumed disease may be offered to the user, so that information effective for improving diagnostic accuracy for a complicating disease and the like may be provided.

Further, the priority may be calculated by applying one or more priority conditions, combined in any manner, selected from the first priority condition to the third priority condition, or the priority may be calculated by any further priority condition or any further combination of priority conditions. By calculating the priority based on a plurality of different viewpoints, the priorities of display item group candidates may be calculated more accurately. It is conceivable that, when a plurality of priority conditions is applied for priority calculation, an intermediate score corresponding to each priority condition is calculated for each display item group candidate and a weighted sum of a plurality of calculated intermediate scores is calculated as the score representing the priority of each display item group candidate. Further, when a plurality of priority conditions is applied for priority calculation, weighting may be implemented such that a greater weight is given to more important condition among the plurality of priority conditions.

As the method in which a specification specifying one of a plurality of display item group candidates displayed on the display screen is obtained and the obtained display item group candidate is obtained as the display item group, any method may be employed. For example, a display item group may be obtained by employing any graphical user interface (GUI) and receiving specification through input from an input unit such as a mouse, a keyboard, or a touch panel.

In each embodiment described above, the display control unit 14 list-displays a plurality of display item group candidates in the order of priority but not limited to this and a plurality of display item group candidates may be displayed with the priorities being represented in any visually recognizable manner. For example, different colors or font sizes may be used for the characters or symbols identifying display item groups according to the priority or indices or frames representing priorities may be attached to the characters or symbols identifying display item groups.

In the mean time, in each embodiment described above, if a plurality of display item group candidates is extracted, the item group extraction unit 13 calculates the priority for each of the plurality of display item group candidates, but not limited to this and the item group extraction unit 13 may be configured not to calculate the priority. In this case, for example, a configuration may be adopted in which the display control unit 14 selectably displays the plurality of extracted display item group candidates on the display screen, and the item group extraction unit 13 obtained a specification of a display item group candidate displayed on the display screen and extracts the specified display item group candidate as the display item group.

Further, not limited to each embodiment described above, and the display item group may be extracted automatically from a plurality of display item group candidates using any arbitrary evaluation method based on priority or the like instead of the configuration in which the plurality of extracted display item group candidates is selectably displayed on the display screen, then the specification of a display item group candidate is obtained, and the obtained display item group candidate is extracted as the display item group. In this case, for example, it is conceivable that the display item group candidate having a highest priority is extracted as the display item group.

Still further, not limited to each embodiment described above, the medical care information display screen may take any form as long as it selectably displays medical care data corresponding to medical care items included in the display item group. In the present embodiment, the display screen takes the form in which medical care data corresponding to each of a plurality of medical care items are displayed along the common time axis but, for example, a configuration may be adopted in which one set of latest medical care data corresponding to each medical care item included in the display item group is displayed.

Further, in each embodiment described herein, in the aforementioned description “medical care item whose medical care data show an abnormal value”, it is preferable that, for each medical care item, a value representing that the value of the medical care data is in an attentive level is properly set to the abnormal value based on the knowledge of medical diagnosis. The absolute value of difference between a medical care data value and a standard value may be determined as the abnormal value if it is greater than a predetermined threshold value. Otherwise, a normal range and an abnormal range may be defined and a medical care data value included in the abnormal range may be determined as the abnormal value. Further, in a positive negative test, medical care data that show positive may be determined as the abnormal value. Still further, different abnormal numerical ranges may be used for different diseases and, in this case, it is conceivable, for example, that an assumed disease of the display target patient is obtained and a different abnormal numerical range is applied to the medical care data of the display target patient according to the assumed disease.

Still further, in each embodiment described herein, in the aforementioned description “a medical care item whose medical care data have a variation which is greater than or equal to a predetermined threshold value”, it is preferable that an appropriate variation during an appropriate period that allows the medical care data to be evaluated as showing a cautious variation is set as the predetermined threshold value based on the knowledge of medical diagnosis for each medical care item. For example, it is conceivable that the absolute value of difference in the value of biological information during a predetermined period, the absolute value of difference in the value of sample test during a predetermined period, or the absolute value of difference in the size (value indicating long diameter, area, or volume) of lesion area of image data during a predetermined period is used as the variation in the medical care data. Further, different variation threshold values may be applied to medical care data of the display target patient for different diseases and, in this case, it is conceivable, for example, that an assumed disease of the display target patient is obtained and a different variation threshold value is applied to the medical care data of the display target patient according to the assumed disease. In the case in which a different abnormal value range or a different variation threshold value is applied for each disease, as the method for obtaining the assumed disease, a method that extracts a disease from the electronic medical record or discharge summary, or any method that extracts a disease based on a plurality of sets of medical care data may be applied.

Further, not limited to each embodiment described above, and a part or whole of the components of the medical care information display control apparatus may be configured by one workstation or by more than one workstation, a server, and a storage device connected through a network. Each of the equipment is controlled by a program that performs medical care information display described herein installed from a recording medium, such as a CD-ROM or the like. The program may be a program installed after being downloaded from a storage unit of a server connected through a network, such as the Internet.

Each of the embodiments described above illustrates only one aspect of the present invention and modifications and applications may be made arbitrarily without departing from the spirit of the present invention.

What is claimed is:

1. A medical care information display control apparatus, comprising:
a target period obtaining unit that obtains a target period;
a medical care information obtaining unit that obtains a plurality of medical care information sets, each correlating a plurality of medical care items, medical care data of a display target patient corresponding to each medical care item, and a registration reference time of the medical care data, and obtains, among the plurality of medical care information sets, a plurality of medical care information sets whose registration reference times fall within the target period as target medical care information;
an item group extraction unit that obtains a plurality of medical care item groups, each correlating a plurality of medical care items to be displayed on a display screen and, from the plurality of medical care item groups, extracts a medical care item group that includes a medical care item of interest which is a predetermined medical care item included in the target medical care information as a display item group; and
a display control unit that displays medical care data of the display target patient corresponding to the plurality of medical care items included in the extracted display item group based on the plurality of medical care information sets.

2. The medical care information display control apparatus as claimed in claim 1, wherein the target period obtaining unit obtains period related information that correlates an assumed disease, a diagnosis and treatment department, and a predetermined reference period in advance to obtain the assumed disease of the display target patient and the diagnosis and treatment department that refers to the display screen, and obtains a predetermined reference period according to the assumed disease of the display target patient and the diagnosis and treatment department that refers to the display screen as the target period based on the period related information.

3. The medical care information display control apparatus as claimed in claim 1, wherein the target period obtaining unit
obtains a further period related information that relates a period determining medical care item group in which a plurality of predetermined medical care items is related and a predetermined reference period;
obtains a medical care item whose medical care data show an abnormal value or a medical care item whose medical care data have a variation which is greater than or equal to a predetermined threshold value with the latest registration reference time among the medical care items included in the plurality of medical care information sets of the display target patient as a latest medical care item; and
obtains the reference period corresponding to the period determining medical care item group that includes the latest medical care item as the target period based on the further period related information.

4. The medical care information display control apparatus as claimed in claim 1, wherein:
if a plurality of medical care item groups that includes the medical care item of interest is extracted, the item group extraction unit calculates a priority for each of the medical care item groups;
the display control unit displays the plurality of medical care item groups as display item group candidates on the display screen with the calculated priorities being represented in a visually recognizable manner; and
the item group extraction unit obtains a specification of a display item group candidate displayed on the display screen and extracts the obtained display item group candidate as the display item group.

5. The medical care information display control apparatus as claimed in claim 4, wherein the item group extraction unit calculates the priority for each medical care item group candidate by weighting such that the higher the matching between the medical care items included in the medical care item group candidate and the medical care items included in the target medical care information, the higher the priority.

6. The medical care information display control apparatus as claimed in claim 4, wherein the item group extraction unit calculates the priority by weighting such that the higher the matching between the medical care items included in the medical care item group candidate and the medical care items whose medical care data show abnormal values and/or the medical care items whose medical care data have variations greater than or equal to a predetermined threshold value among the medical care items of the target medical care information, the higher the priority.

7. The medical care information display control apparatus as claimed in claim 1, wherein the medical care item of interest is a medical care item whose medical care data show an abnormal value and/or a medical care item whose medical care data have a variation greater than or equal to a predetermined threshold value among the medical care items of the target medical care information.

8. The medical care information display control apparatus as claimed in claim 1, wherein the medical care item group includes, with respect to each disease, a plurality of related medical care items used for diagnosis of each disease.

9. A medical care information display control method to be performed by a medical care information display control apparatus, the method comprising:
a target period obtaining step that obtains a target period;
a medical care information obtaining step that obtains a plurality of medical care information sets, each relating a plurality of medical care items, medical care data of a display target patient corresponding to each medical care item, and a registration reference time of the medical care data, and obtains, among the plurality of medical care information sets, a plurality of medical care information sets whose registration reference times fall within the target period as target medical care information;
an item group extraction step that obtains a plurality of medical care item groups, each correlating a plurality of medical care items to be displayed on a display screen and, from the plurality of medical care item groups, extracts a medical care item group that includes a medical care item of interest which is a predetermined medical care item included in the target medical care information as a display item group; and
a display control step that displays medical care data of the display target patient corresponding to the plurality of medical care items included in the extracted display item group based on the plurality of medical care information sets.

10. A non-transitory computer readable recording medium on which is recorded a medical care information display control program that causes a computer to function as:
a target period obtaining unit that obtains a target period;
a medical care information obtaining unit that obtains a plurality of medical care information sets, each correlating a plurality of medical care items, medical care data of a display target patient corresponding to each medical care item, and a registration reference time of the medical care data, and obtains, among the plurality of medical care information sets, a plurality of medical care information sets whose registration reference times fall within the target period as target medical care information;
an item group extraction unit that obtains a plurality of medical care item groups, each correlating a plurality of medical care items to be displayed on a display screen and, from the plurality of medical care item groups, extracts a medical care item group that includes a medical care item of interest which is a predetermined medical care item included in the target medical care information as a display item group; and
a display control unit that displays medical care data of the display target patient corresponding to the plurality of medical care items included in the extracted display item group based on the plurality of medical care information sets.
